(19) United States
(12) Patent Application Publication
(10) Pub. No.: US 2026/0296023 A1
(43) Pub. Date: Oct. 1, 2026

(54) LIQUID DISCHARGE APPARATUS AND IMAGE FORMING APPARATUS

(71) Applicants: Masashi OHNISHI, Kanagawa (JP); Yusuke TOKUNAGA, Kanagawa (JP)

(72) Inventors: Masashi OHNISHI, Kanagawa (JP); Yusuke TOKUNAGA, Kanagawa (JP)

(21) Appl. No.: 19/565,545

(22) Filed: Mar. 13, 2026

(30) Foreign Application Priority Data
Mar. 28, 2025 (JP) 2025-055609

(51) Int. Cl. B41J 2/165; B41J 29/17

(52) U.S. Cl. CPC B41J 2/16511; B41J 29/17; B41P 2235/27

(57) ABSTRACT

A liquid discharge apparatus includes: a head having nozzle surface having nozzles on the nozzle surface, to discharge liquid from the nozzles in a discharge direction; a suction cap having a lip contactable with the nozzle surface to cap the nozzle surface with the suction cap, the suction cap including an absorber in the suction cap, a cap cleaner, having liquid absorbability, to contact with the lip and clean the lip of the suction cap; a support supporting the cap cleaner to be movable in a capping direction opposite to the discharge direction; and a biasing member configured to bias the cap cleaner toward the suction cap in the discharge direction.

### CROSS-REFERENCE TO RELATED APPLICATION

This patent application is based on and claims priority pursuant to 35 U.S.C. § 119(a) to Japanese Patent Application No. 2025-055609, filed on Mar. 28 , 2025, in the Japan Patent Office, the entire disclosure of which is hereby incorporated by reference herein.

### BACKGROUND

### Technical Field

The present embodiment relates to a liquid discharge apparatus and an image forming apparatus.

### Related Art

A liquid discharge apparatus includes a head that discharges liquid, a suction cap that caps a nozzle surface of the head, and a cleaner having liquid absorbability, and brings the cleaner into contact with an edge of an opening of the suction cap to clean the edge.

### SUMMARY

The present disclosure provides a liquid discharge apparatus including: a head having nozzle surface having nozzles on the nozzle surface, to discharge liquid from the nozzles in a discharge direction; a suction cap having a lip contactable with the nozzle surface to cap the nozzle surface with the suction cap, the suction cap including an absorber in the suction cap, a cap cleaner, having liquid absorbability, to contact with the lip and clean the lip of the suction cap; a support supporting the cap cleaner, the cap member in the support being movable in a capping direction opposite to the discharge direction; and a biasing member configured to bias the cap cleaner toward the suction cap in the discharge direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic explanatory view of a printer;

FIG. 2 is an explanatory plan view of a main part of the printing machine;

FIG. 3 is an explanatory side view of the printing machine during printing;

FIG. 4 is an explanatory side view of the printing machine during non-printing;

FIGS. 5A and 5B are explanatory front views of the printing machine during printing and non-printing, respectively;

FIG. 6 is a block diagram of a controller of the printing machine;

FIG. 7 is a flowchart of control of the printing machine;

FIG. 8 is a perspective view of a support mechanism of first stampers 231;

FIG. 9 is a cross-sectional view taken along line X-X of FIG. 8 in a separated state;

FIG. 10 is a cross-sectional view of the same in a contact state; and

FIGS. 11A and 11B are explanatory views of a defect of a conventional configuration.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

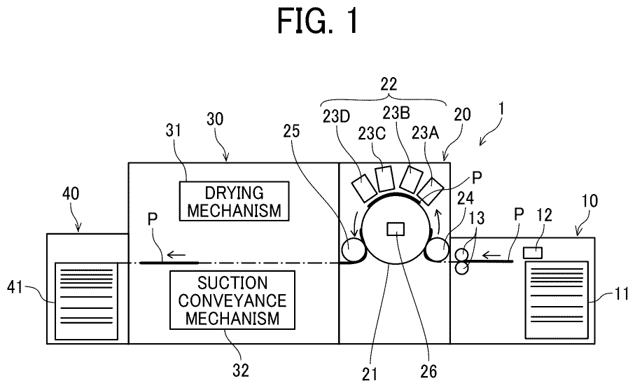

A printer (image forming apparatus) that is a liquid discharge apparatus will be described. An outline of the printer will be described. FIG. 1 is a schematic cross-sectional side view of the printer 1 according to the first embodiment of the present disclosure.

In the printer 1, a printing device 20 applies a liquid to a sheet P carried from a loading device 10, thereby performing printing, and the drying device 30 dries the liquid adhering to the sheet P, after which the sheet P is ejected to an ejection device 40.

The loading device 10 feeds the sheet P from a loading tray 11 by a feeding device 12. After reaching a pair of register rollers 13, the fed sheet P is fed to the printing device 20 by the pair of register rollers 13.

The sheet P conveyed from the loading device 10 to the printing device 20 is conveyed in accordance with rotation of transfer cylinders 24 and 25 while the leading end of the sheet P is being gripped by a sheet gripper provided on the transfer cylinders 24 and 25. The sheet P conveyed by the transfer cylinder 24 is delivered to a carrying drum 21 at a position facing the carrying drum 21.

A sheet gripper is also provided on the carrying drum 21, and the leading end of the sheet P is gripped by the sheet gripper. Multiple suction holes are dispersedly formed on the surface of the carrying drum 21. A suction device 26 generates a suction airflow toward the inside of the carrying drum 21 through the suction holes.

Then, the sheet P delivered from the transfer cylinder 24 to the carrying drum 21 is conveyed in accordance with rotation of the carrying drum 21 while being attracted on the carrying drum 21 due to the suction airflow with its leading end being gripped by the sheet gripper.

When the sheet P carried by the carrying drum passes through a region facing the liquid discharge section 22, the liquid of each color is discharged from the dischargers 23, and an image corresponding to the print data is printed on the sheet P. A discharge operation of each of the dischargers 23 of the liquid discharge section 22 is controlled by drive signals corresponding to the print data.

For example, the discharger 23A discharges a liquid of cyan (C), the discharger 23B discharges a liquid of magenta (M), the discharger 23C discharges a liquid of yellow (Y), and the discharger 23D discharges a liquid of black (K), respectively.

After the sheet P conveyed from the printing device 20 is received by the suction conveyance mechanism 32, the sheet P is conveyed to pass through the drying mechanism 31 and delivered to the ejection device 40. When the sheet P passes through the drying mechanism 31, a drying treatment is performed.

The plurality of sheets P conveyed from the drying device 30 is sequentially stacked and held on the ejection tray 41.

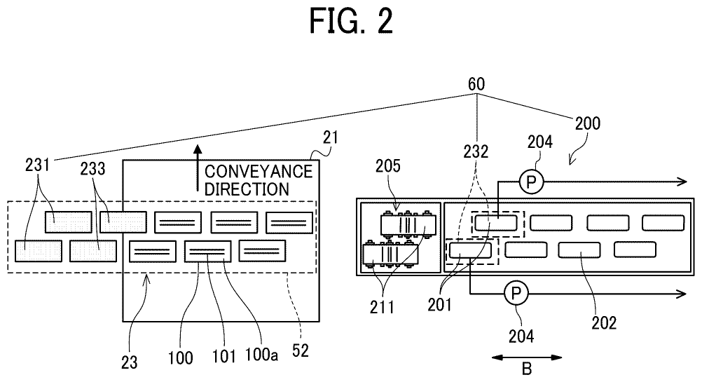

Next, the discharger and a head cleaning device will be described with reference to FIGS. 2 to 4.

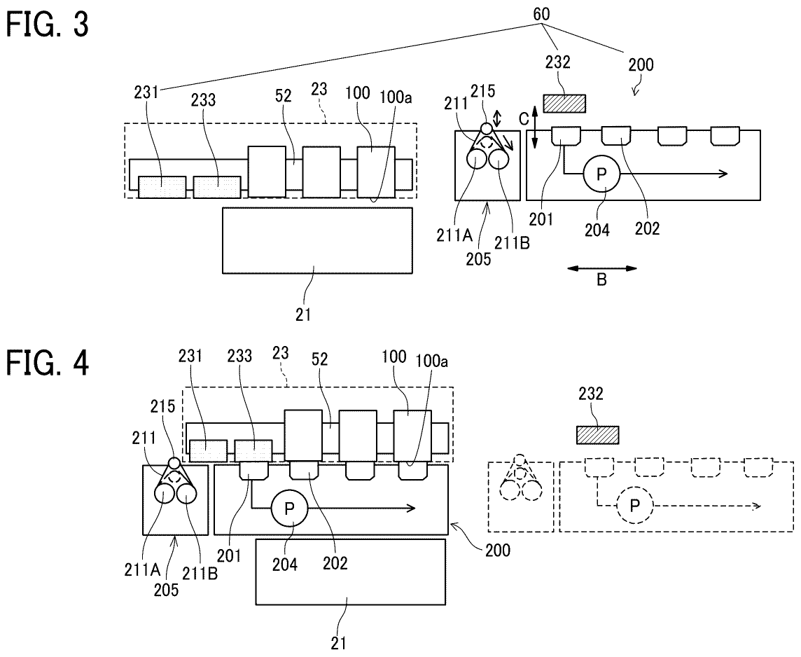

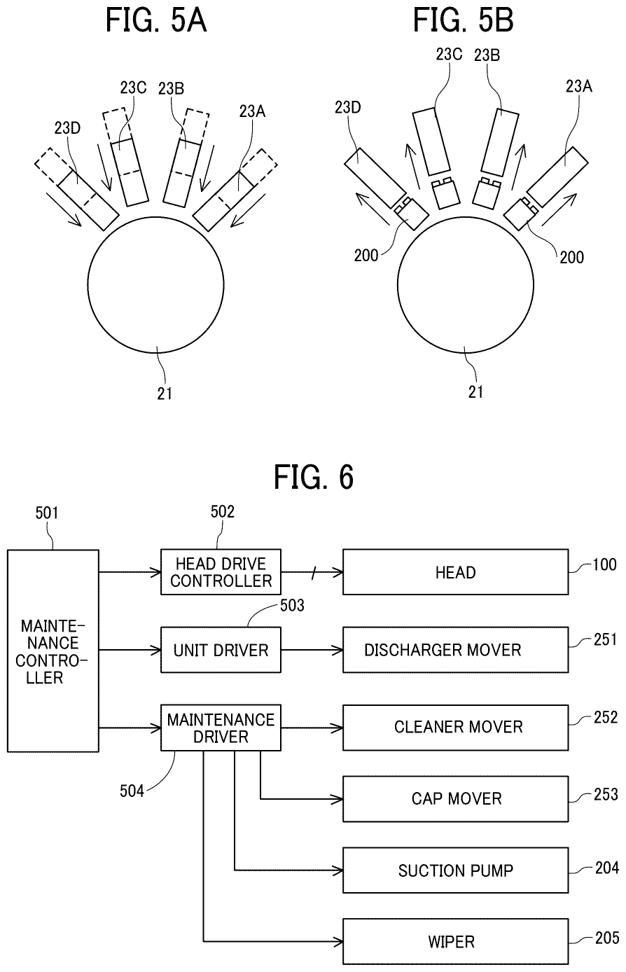

FIG. 2 is an explanatory plan view of a main part around the discharger and the head cleaning device, FIG. 3 is an explanatory side view during printing, FIG. 4 is an explanatory side view during non-printing (standby), and FIGS. 5A and 5B are explanatory front views for explaining states of printing and non-printing, respectively.

In the discharger 23, a plurality of liquid discharge heads (also simply referred to as “heads”) 100 each having a nozzle surface 100a having a nozzle row 101 is disposed on a head base 52 in a staggered manner. In the illustrated one head, two head members are disposed side by side in a lateral direction. The nozzle row 101 has a plurality of nozzles arrayed in a longitudinal direction of the head 100. Liquid is discharged from each of the plurality of nozzles.

As illustrated in FIG. 3, the discharger 23 is disposed so as to be movable back and forth in the direction of arrow A with respect to the circumferential surface of the carrying drum 21. Then, during printing, the discharger 23 moves in the direction of the arrow from the position indicated by the broken line in FIG. 5A to the printing position indicated by the solid line in FIG. 5A. The position of the discharger 23 in FIG. 3 corresponds to the printing position indicated by the solid line in FIG. 5A. During non-printing, the discharger 23 moves in the direction of the arrow of FIG. 5B and moves to a retracted position (non-printing position) indicated by the solid line in FIG. 5B.

A head cleaner 200 is a head maintenance device (maintenance and recovery device) constituting a head cleaning device 60. The head cleaner 200 includes a suction cap 201 that caps the nozzle surface 100a of the head 100, a moisturizing cap 202 that caps the nozzle surface 100a of the head 100, and a wiper 205 that wipes the nozzle surface 100a of the head 100.

A suction pump 204 as a suction portion is coupled to the suction cap 201. No suction portion is coupled to the moisturizing cap 202. The suction cap 201 is disposed so as to be vertically movable in the direction of arrow C independently of the moisturizing cap 202 (see FIG. 3).

The wiper 205 includes a web 211 that wipes the nozzle surface 100a, and a pressing member 215 that presses the web 211 against the nozzle surface 100a. The web 211 is fed out from a feeding roller 211A and wound around a winding roll 211B. The pressing member 215 is vertically movable between the position indicated by the solid line in FIG. 3 where the web 211 is pressed against the nozzle surface 100a and the retracted position indicated by the broken line in FIG. 3 where the web 211 is retracted from the nozzle surface 100a.

The wiper 205 is a nozzle surface wiping portion, and also serves as a cleaner wiping portion that wipes a second stamper 232, which is a second cleaner to be described later.

The head cleaner 200 is disposed so as to be movable back and forth in the direction of arrow B, which is an axial direction of the carrying drum 21. The head cleaner 200 moves to the retracted position illustrated in FIGS. 2 and 3 during printing, and moves to the capping position illustrated in FIGS. 5A and 5B during non-printing (standby).

The second stamper 232, which is a second cleaner for cleaning the suction cap 201, is disposed above the suction cap 201 of the head cleaner 200. A first stamper 231, which is a first cleaner, is disposed on the head base 52 of the discharger 23. The head cleaner 200, the second stamper 232, and the first stamper 231 constitute the head cleaning device 60. A suction cap sealing member 233 is also disposed on the head base 52 of the discharger 23.

The first stamper 231 includes an absorber such as a porous member. The second stamper 232 includes a plate-shaped member such as a metal plate or a rubber plate. The second stamper 232 includes a member having lower liquid absorbability than the first stamper 231. The first stamper 231 is replaceable. The first stamper 231 may be referred to as a “cap cleaner”.

Next, a part related to head maintenance control will be described with reference to an explanatory block diagram of FIG. 6.

A maintenance controller 501 drives each head 100 of the discharger 23 through a head drive controller 502 to purge the liquid (discharge for head recovery).

The maintenance controller 501 drives a head mover 251 that moves the discharger 23 up and down via a unit driver 503. The head mover 251 may be referred to as a “head mover”, and various types of head movers can be adopted. The discharger mover may be referred to also as a “discharger advancing and retracting mechanism” or a “discharge mover”.

For example, a pair of lifting mechanisms is provided at both longitudinal ends of the head base 52. The lifting mechanism is provided with a ball screw, an electric motor, and a nut attached to a screw shaft, and the nut is held by the head base 52. The head base 52 moves up and down together with the nut by forward and reverse rotation of the electric motor.

The maintenance controller 501 drives a cleaner mover 252 that moves the head cleaner 200 back and forth in the direction of arrow B and drives a cap mover 253 that vertically moves the suction cap 201 via a maintenance driver 504.

The cap mover 253 corresponds to the suction cap mover, and various suction cap mover can be adopted. For example, the suction cap 201 is provided with a cam follower, and is brought into contact with a peripheral surface of a cam that rotates on a shaft rotated by a cap advancing and retracting motor, and the suction cap 201 is moved accordingly.

The maintenance controller 501 controls the driving of the suction pump 204 via the maintenance driver 504 to control the driving necessary for the operation of the wiper 205 such as winding of the web 211.

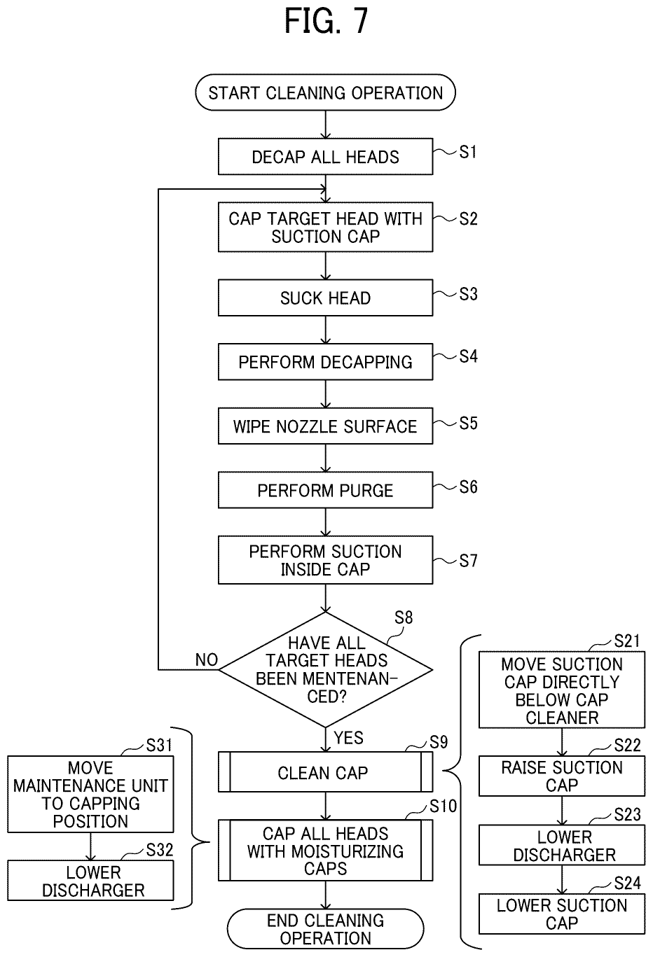

Next, control of the maintenance operation will be described with reference to the flowchart of FIG. 7.

When the maintenance operation (head cleaning operation) is started during non-printing, all the heads 100 (dischargers 23) are raised to de-cap the moisturizing cap 202 (step S1, hereinafter referred to as “S1”).

Next, a maintenance target head is determined, the head cleaner 200 is moved in the direction of arrow B (see FIG. 4), the suction cap 201 faces the maintenance target head 100, and the suction cap 201 is raised to cap the nozzle surface 100a of the target head 100 (S2).

The suction pump 204 is driven to perform head suction of sucking and discharging the liquid from a nozzle 100n of the head 100 into the suction cap 201 (S3), and after the suction, the suction cap 201 is decapped from the target head 100 (S4).

Next, the nozzle surface 100a is wiped (web wiped) with the web 211 of the wiper 205, and the web 211 is wound (S5). Thereafter, purge is performed (S6), and the suction pump 204 is driven to suck the waste liquid in the suction cap 201 (suction in the cap) (S7).

Then, it is determined whether or not the maintenance of all the target heads has been completed (S8), and the process returns to step S2 and repeats the processes up to step S7 until the maintenance of all the target heads is completed.

When the maintenance of all the target heads is completed, the cap cleaning operation is executed (S9). The cap cleaning operation is mainly a cleaning operation using the first stamper 231, but prior to this, a cleaning operation using the second stamper 232 not indicated in the flowchart may be performed. The cleaning operation is as described below.

The head cleaner 200 is moved to a position where the suction cap 201 faces the second stamper 232, and the suction cap 201 is raised and brought into contact with the second stamper 232, so that the waste liquid adhering to the contact part of the suction cap 201 is transferred to the second stamper 232. The second stamper 232 is wiped by the wiper 205, and the web 211 is wound.

The cleaning operation using the first stamper 231 is performed as described below. The head cleaner 200 is moved below the discharger 23 to bring the suction cap 201 to a position facing the first stamper 231 (S21). Then, the suction cap 201 is raised to be brought into contact with or close to the first stamper 231 (S22).

In the present embodiment, the first stamper 231 is moved to a position where the first stamper 231 comes into contact with the suction cap 201 or a position where the contact force is increased with respect to the suction cap 201 that comes into contact with the first stamper or comes close to the first stamper 231. In order to move the first stamper 231, a discharge head vertical movement mechanism is driven and controlled to move the head base 52 of the head. This drive control is performed by a maintenance controller in FIG. 6.

Next, all the heads 100 are lowered to perform the capping operation of capping with the moisturizing cap 202 (S10). In this capping operation, first, the head cleaner 200 is moved in the direction of arrow B (see FIG. 4), and the suction cap 201 and the moisturizing cap 202 are positioned to face the suction cap sealing member 233 and each head 100 (S31). Thereafter, all the heads 100 are lowered and capped with the moisturizing cap 202.

Next, a support structure of the first stamper 231 will be described. Since the suction cap that seals the inkjet head is easily contaminated with ink, it is necessary to periodically clean the suction cap. When the ink contamination of the suction cap progresses, the adhesion to the nozzle surface is deteriorated, and the head cannot be protected. Therefore, a first stamper 231 having absorbability is brought into contact with a nip (opening edge) which is a contact portion of the cap with the head surface so as to perform cleaning.

In the conventional method of bringing the first stamper 231 having absorbability into contact with the nip of the suction cap 201, an absorber 410 in the suction cap 201 and the first stamper 231 also come into contact with each other, and the absorption performance of the first stamper 231 is deteriorated by sucking the ink in the suction cap 201. As a result, there is a disadvantage that it is necessary to frequently replace the absorber 410 in order to maintain absorption performance. The reference signs in parentheses after the configuration names are the reference signs of the corresponding members described with reference to FIGS. 1 to 7. Hereinafter, in a case where terms such as superordinate concepts are similarly used, the reference numerals of the corresponding members described with reference to FIGS. 1 to 7 are written in parentheses.

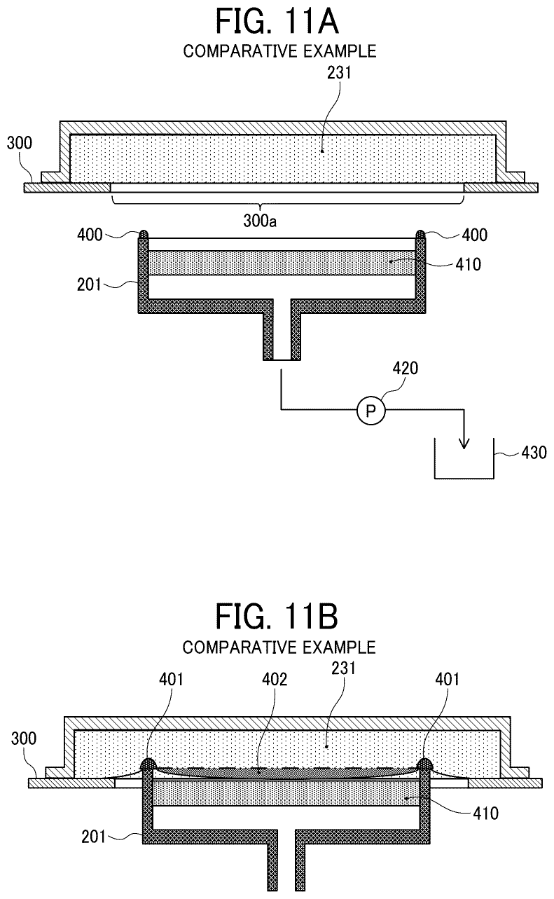

FIGS. 11A and 11B are explanatory views of a defect of a conventional configuration. FIG. 11A illustrates a state in which the first stamper 231 and the suction cap 201 are separated from each other, and FIG. 11B illustrates a state in which the first stamper 231 is brought into contact with the nip of the suction cap 201. In the conventional configuration, the first stamper 231 is brought into contact with the nip of the suction cap 201, and ink 400 adhering to the nip of the suction cap 201 is transferred to the first stamper 231 so as to perform cleaning.

At this time, depending on the contact amount, the first stamper 231 comes into contact with the absorber 410 in the suction cap 201 and sucks the ink. As a result, the absorption performance of the first stamper 231 deteriorates in a short period of time. FIG. 11B illustrates that, in addition to contamination 401 on the first stamper 231 due to the ink adhering to the nip, contamination 402 on the ink transferred by the absorber 410 is also generated.

In a configuration in which there is a pump 420 that sucks the ink under the suction cap, the ink is sucked by the suction force of the pump 420 and discharged to a waste container 430. The absorber 410 becomes a part of the suction path inside the suction cap 201. The ink adheres to the absorber 410 in the suction cap 201 when the ink is sucked from the head 100. When the absorber 410 in the suction cap 201 and the first stamper 231 come into contact with each other, the ink moves from the absorber 410 in the suction cap 201 to the first stamper 231, and the first stamper 231 is contaminated.

In the conventional structure, when the first stamper 231 is brought into contact with the nip of the suction cap 201, when the contact amount is small, the cap cleaning becomes insufficient, and when the contact amount is large, the first stamper 231 comes into contact with the absorber 410 in the suction cap 201, and sucks the ink, so that the absorption performance is deteriorated in a short period of time. That is, the conventional configuration has a small allowable value for variation in contact amount.

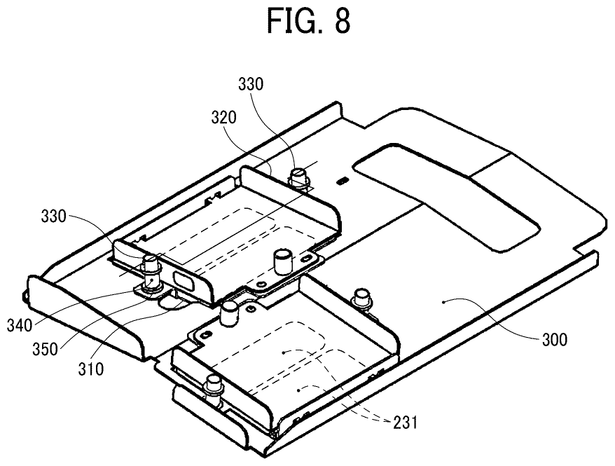

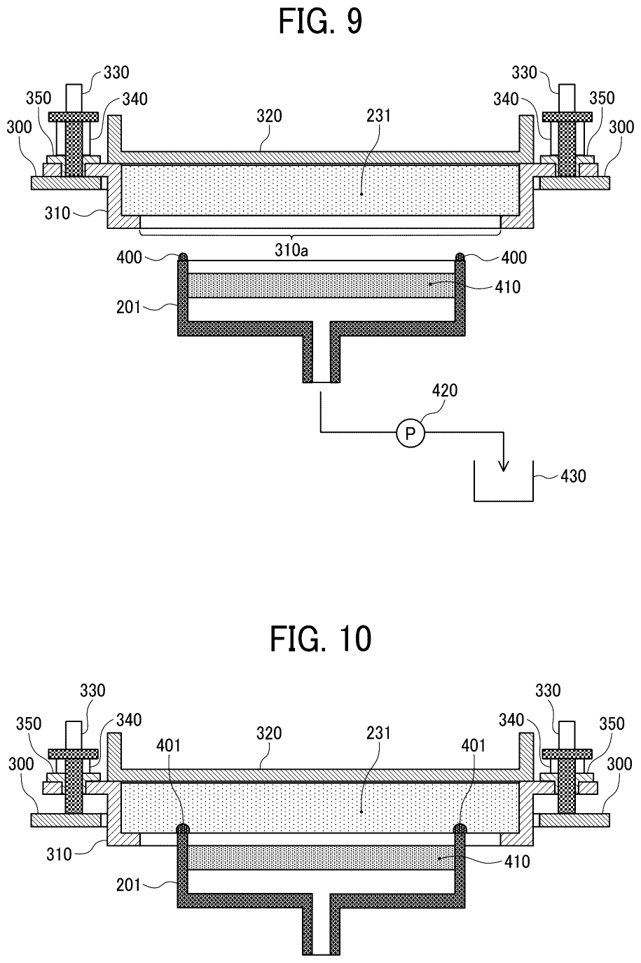

In the present embodiment, in order to solve such a disadvantage, the configurations of FIGS. 8 to 10 are adopted. FIG. 8 is a perspective view of a support mechanism of the first stampers 231. FIG. 9 is a cross-sectional view taken along line X-X in FIG. 8 in a separated state. FIG. 10 is a cross-sectional view of the same in a contact state. The support mechanism may be referred to simply as “a support”.

The present embodiment includes a first holder 300 of the first stamper 231. As illustrated in FIG. 2 and the like, the first holder 300 is fixed to the head base 52 of the head 100.

The separation-contact mechanism of the head base 52 serves as a portion for relatively approaching and separating the suction cap 201 and the first holder 300. A second holder 310 of the first stamper 231 is provided. The second holder 310 includes a movable support portion movably supported on the first holder 300 in the capping direction. Biasing member 340 that press the second holder 310 toward the cap are provided.

In the movable support portion, the second holder 310 is supported by the biasing member 340 via two main and subordinate supported support shafts 330 and sliders 350. The example illustrated in FIG. 8 also includes a lid member 320 that forms a wall of the accommodation space of the first stamper 231. The lid member 320 may be coupled to the second holder 310, or may be detachably attached to the upper surface of the first holder 300 apart from the second holder 310. In FIG. 8, two cap cleaners 231 are provided as indicated by the broken lines for one second holder 310. Accordingly, the head 100 illustrated in FIG. 2 includes two head members corresponding to the two cap cleaners 231.

The cap pressing force of the cap mover 253 (pressing member) that presses the suction cap 201 against the head 100 is larger than the sum of the pressing force that presses the second holder 310 toward the cap side and the weights of the first stamper 231 and the second holder 310. According to this, when the first stamper 231 comes into contact with the suction cap 201, the second holder 310 moves, and absorbs the deformation of the first stamper 231 to make the contact distance between the suction cap 201 and the first stamper 231 constant. Therefore, excessive contact between the suction cap and the first stamper 231 can be reduced.

The distance between the lip of the suction cap 201 and the absorber 410 is larger than the deformation amount (protrusion amount) of the first stamper 231 when the suction cap 201 is pressed against and protruding into the first stamper 231. That is, the deformation amount of the lip is the protrusion amount of the surface portion with no deformation or the least deformation when viewed from the most recessed portion pressed by the lip. When the protrusion amount is smaller than the distance, the surface portion does not come into contact with the liquid absorbing member of the cap.

In order to move the suction cap 201 relatively close to the first holder 300 or separate the suction cap 201 from the first holder 300, a head lifting mechanism that approaches and separates from the printing surface (the surface of the carrying drum 21) can be used.

According to this, the existing mechanism can be used to manage the contact amount.

According to the above embodiment, the first stamper 231 is held on the second holder 310 that is movably supported on the first holder 300 in a state of being pressed in the direction of the suction cap 201. With the present configuration, even when the contact amount is large when the first stamper 231 is brought into contact with the nip of the suction cap 201, the suction cap 201 pushes up the first stamper 231 and the second holder 310, so that an excessive contact state can be avoided. Therefore, contact between the absorber 410 in the suction cap 201 and the first stamper 231 can be avoided, and the absorption performance of the first stamper 231 is not deteriorated in a short period of time.

Although it is conceivable to adjust the pressing force on the suction cap 201 side, the suction cap 201 includes the pressing member to seal the nozzle surface of the head, and the pressing force against the cap cleaner is not equal to sealing of the cap. Therefore, it is necessary to provide a plurality of springs on the cap side, and there is a disadvantage that the structure becomes complicated and a maintenance unit becomes large. In the present embodiment, by providing the pressing mechanism on the cap cleaning side, the configuration can be simplified.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

In the present embodiment, discharged liquid is not limited to a particular liquid as long as the liquid has a viscosity or surface tension to be discharged from a head (liquid discharge head). However, preferably, the viscosity of the liquid is not greater than 30 mPa·s under ordinary temperature and ordinary pressure or by heating or cooling. Specific examples of such liquids include, but are not limited to, solutions, suspensions, and emulsions containing solvents (e.g., water, organic solvents), colorants (e.g., dyes, pigments), functionality imparting materials (e.g., polymerizable compounds, resins, surfactants), biocompatible materials (e.g., DNA (deoxyribonucleic acid), amino acid, protein, calcium), and/or edible materials (e.g., natural colorants). Such liquids can be used as inkjet inks, surface treatment liquids, liquids for forming compositional elements of electric or luminous elements or electronic circuit resist patterns, and three-dimensional object forming material liquids.

Examples of an energy source for generating energy to discharge liquid include a piezoelectric actuator (a laminated piezoelectric element or a thin-film piezoelectric element), a thermal actuator that employs a thermoelectric conversion element, such as a heating resistor (element), and an electrostatic actuator including a diaphragm and opposed electrodes.

The term “liquid discharge apparatus” used herein represents an apparatus including the liquid discharge head to drive the liquid discharge head to discharge liquid. The liquid discharge apparatus may be, for example, any apparatus that can discharge liquid to a medium onto which liquid can adhere or any apparatus to discharge liquid toward gas or into a different liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “material onto which liquid can adhere” represents a material on which liquid is at least temporarily adhered, a material on which liquid is adhered and fixed, or a material into which liquid is adhered to permeate. Examples of the “material on which liquid can adhere” include recording media, such as paper sheet, recording paper, recording sheet of paper, film, and cloth, electronic component, such as electronic substrate and piezoelectric element, and media, such as powder layer, organ model, and testing cell. The “material on which liquid can adhere” includes any material on which liquid can adhere, unless particularly limited.

Examples of the “material onto which liquid can adhere” include any materials on which liquid can adhere even temporarily, such as paper, thread, fiber, fabric, leather, metal, plastic, glass, wood, and ceramic.

The liquid discharge apparatus may be an apparatus to move the liquid discharge head and the medium onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The terms “image formation,” “recording,” “printing,” “image printing,” and “fabricating” used herein may be used synonymously with each other.

A liquid discharge apparatus includes: a head (100) having nozzle surface (100a) having nozzles on the nozzle surface (100a), to discharge liquid from the nozzles in a discharge direction; a suction cap (201) having a lip contactable with the nozzle surface to cap the nozzle surface with the suction cap (201), the suction cap including an absorber (410) in the suction cap (201), a cap cleaner (231), having liquid absorbability, to contact with the lip and clean the lip of the suction cap (201); a support supporting the cap cleaner (231) to be movable in a capping direction opposite to the discharge direction; and a biasing member (340) configured to bias the cap cleaner (231) toward the suction cap (201) in the discharge direction.

The liquid discharge apparatus further includes: a cap mover to move the suction cap (201) toward the head (100) to cap the nozzle surface, wherein the cap mover moves the suction cap (201) to the cap cleaner (231) in the capping direction to: contact the lip of the suction cap (201) with the cap cleaner (231); and moves the cap cleaner (231) in the capping direction to deform the biasing member (340) via the cap cleaner (231).

The suction cap (201) has a first distance between the lip of the suction cap (201) and a top surface of the absorber (410) in the capping direction, and the lip of the suction cap (201) protrudes into the cap cleaner (231) for a second distance smaller than the first distance in the capping direction when the suction cap (201) deforms the biasing member (340) via the cap cleaner (231).

The support includes: a holder (310) holding the cap cleaner (231); a support shaft (330) supporting the holder (310); a slider (350) coupled to the holder (310) and movable along the support shaft (330); and the biasing member (340) configured to bias the slider (350) in the discharge direction.

The liquid discharge apparatus further includes a head mover (251) to move the head (100) relative to a target in the discharge direction, wherein the head mover (251) moves the cap cleaner to: contact the cap cleaner (231) with the lip of the suction cap (201); or separate the cap cleaner (231) from the lip of the suction cap (201).

The liquid discharge apparatus further includes: a head base (52) supporting the head (100) and the cap cleaner (231), wherein the head mover (251) moves the head base (52) to move the cap cleaner (231) in the discharge direction, to contact the cap cleaner (231) with the lip of the suction cap (201) to clean the lip of the suction cap (201).

An image forming apparatus includes the liquid discharge apparatus.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above description is an example, and the present embodiment has unique effects for each of the following aspects. Reference signs in parentheses with which constituents are denoted in each aspect indicate the corresponding members. However, the constituents are not limited to these examples of members.

Aspect 1

According to Aspect 1, a liquid discharge apparatus includes: a head (100) configured to discharge liquid; a suction cap (201) configured to cap a nozzle surface of the head (100); and a cap cleaner (231) having liquid absorbability, the liquid discharge apparatus bringing the cap cleaner (231) into contact with an edge of an opening of the suction cap (201) to clean the edge, the liquid discharge apparatus further including an absorber (410) configured to be accommodated in the suction cap (201); a support mechanism configured to support the cap cleaner (231) so as to be retractable to a side opposite to the suction cap (201); and a biasing member (340) configured to bias the cap cleaner (231) toward the suction cap (201) by elastic deformation.

Aspect 2

According to Aspect 2, in the liquid discharge apparatus of Aspect 1, the biasing member (340) is subjected to contraction deformation via the cap cleaner (231) by the suction cap (201) moved by a cap mover (253).

### Aspect 3

According to Aspect 3, in the liquid discharge apparatus of Aspect 2, a protruding amount of a portion in the opening protruding from a portion deformed and recessed by being pressed by the edge of the opening of the suction cap (201) in a contraction deformation state is smaller than a distance between the edge of the opening of the suction cap (201) and a surface of the absorber (410).

Aspect 4

According to Aspect 4, in the liquid discharge apparatus of any one of Aspects 1 to 3, the support mechanism includes a support shaft (330) and a holder (310) that is supported by the support shaft (330) via a slider (350) and holds the cap cleaner (231).

Aspect 5

According to Aspect 5, in the liquid discharge apparatus of any one of Aspects 1 to 4, a head mover (251) that separates/contacts the head (100) from/with a liquid discharge target is used for contact/separation between the cap cleaner (231) and the edge of the opening of the suction cap (201).

Aspect 6

According to Aspect 6, in the liquid discharge apparatus of Aspect 5, the cap cleaner (231) is supported by a head base moved by the head mover, the liquid discharge apparatus including a controller (501) configured to control driving of the head mover (251) to move the head base to a position where a contact force is increased with respect to the suction cap (201) that is moved by a cap mover (253) for separation from and contact with the cap cleaner (231) and takes a position in contact with or in proximity to the cap cleaner (231).

Aspect 7

According to Aspect 7, an image forming apparatus uses the liquid discharge apparatus of any one of Aspects 1 to 6.

Any one of the above-described operations may be performed in various other ways, for example, in an order different from the one described above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid discharge apparatus comprising:
a head having nozzle surface having nozzles on the nozzle surface,
to discharge liquid from the nozzles in a discharge direction;
a suction cap having a lip contactable with the nozzle surface to cap the nozzle surface with the suction cap,
the suction cap including an absorber in the suction cap,
a cap cleaner, having liquid absorbability, to contact with the lip and clean the lip of the suction cap;
a support supporting the cap cleaner to be movable in a capping direction opposite to the discharge direction; and
a biasing member configured to bias the cap cleaner toward the suction cap in the discharge direction.

2. The liquid discharge apparatus according to claim 1, further comprising:
a cap mover to move the suction cap toward the head to cap the nozzle surface,
wherein the cap mover moves the suction cap to the cap cleaner in the capping direction to:
contact the lip of the suction cap with the cap cleaner; and
moves the cap cleaner in the capping direction to deform the biasing member via the cap cleaner.

3. The liquid discharge apparatus according to claim 2,
wherein the suction cap has a first distance between the lip of the suction cap and a top surface of the absorber in the capping direction, and
the lip of the suction cap protrudes into the cap cleaner for a second distance smaller than the first distance in the capping direction when the suction cap deforms the biasing member via the cap cleaner.

4. The liquid discharge apparatus according to claim 1,
wherein the support includes:
a holder holding the cap cleaner;
a support shaft supporting the holder;
a slider coupled to the holder and movable along the support shaft; and
the biasing member configured to bias the slider in the discharge direction.

5. The liquid discharge apparatus according to claim 1, further comprising a head mover to move the head relative to a target in the discharge direction,
wherein the head mover moves the cap cleaner to:
contact the cap cleaner with the lip of the suction cap; or
separate the cap cleaner from the lip of the suction cap.

6. The liquid discharge apparatus according to claim 5, further comprising:
a head base supporting the head and the cap cleaner,
wherein the head mover moves the head base to move the cap cleaner in the discharge direction,
to contact the cap cleaner with the lip of the suction cap to clean the lip of the suction cap.

7. An image forming apparatus comprising the liquid discharge apparatus according to claim 1.
